(19) United States
(12) Patent Application Publication
(10) Pub. No.: US 2003/0070632 A1
(43) Pub. Date: Apr. 17, 2003

(54) Spark-ignition rotary internal-combustion engine

(76) Inventor: Claudio De Bei, Bassano del Grappa (IT)

Correspondence Address: BUCKNAM AND ARCHER, 1077 NORTHERN BOULEVARD, ROSLYN, NY, 11576, US

(21) Appl. No.: 10/019,372

(22) PCT Filed: Apr. 19, 2001
(86) PCT No.: PCT/EP01/04453

(30) Foreign Application Priority Data
Apr. 26, 2000 (IT) VI2000A000076

(51) Int. Cl. F02B 57/00; F02F 1/10; F01P 1/04

(52) U.S. Cl. 123/44 R; 123/43 R; 123/41.35; 123/41.72

(57) ABSTRACT

A spark-ignition rotary internal-combustion engine, having a plurality of pistons (7) which perform a reciprocating motion inside cylinders (6) arranged so as to be equally angularly spaced on a same circumference, the cylinders (6) being formed in a rotating body or rotor (2) which rotates coaxially inside a fixed body or stator (1), in which the inlet duct (9) for the air-fuel mix, the burnt gas exhaust duct (8) and the spark-plug recess (10) are provided.

### TECHNICAL FIELD

The invention relates to a spark-ignition rotary internal-combustion engine.

### BACKGROUND ART

Among the many projects that have been presented for creating a new engine having improved characteristics with respect to the ones still presently in use, only a few have followed an innovative path which is entirely revolutionary with respect to current engines, which have now been available for over one hundred years.

In recent times, so-called rotary engines, or lobed engines and other engines of various kinds and functionalities, in which the operating cycles are similar to those of conventional engines, but in which the rod-and-crank system lacks, have been presented.

Merely as an example, mention is made of the Wankel engine, composed of two bodies arranged one inside the other so that the outer body is fixed and the inner one has a “planetary” motion which, at each rotation through 360°, generates variable-volume combustion chambers.

### DISCLOSURE OF THE INVENTION

The invention consists in providing a rotary internal-combustion engine which has the same operating principles as reciprocating engines, of the two-stroke and four-stroke types, but has a rotary operation.

This aim is achieved with a rotary internal-combustion engine, characterized in that it uses a plurality of pistons having a reciprocating motion, each piston being able to slide within a cylinder in an identical spaced angular arrangement in a same circumference, where the cylinders are accommodated in appropriately provided seats formed in a rotating body or rotor which rotates coaxially inside a fixed body or stator, in which the inlet ducts for the air-fuel mix and the exhaust duct for the burnt gases are formed together with the seat for the spark-plug, as in conventional internal-combustion engines.

The surfaces between the rotor and the stator have minimal tolerances and are manufactured with a spherical surface so as to give perfect balancing to the interior of the system in rotary motion.

The rotor, which assumes the shape of a spherical sector with two flat faces, is supported by a fixed supporting shaft which is rigidly coupled to the body of the stator by using two lateral flanges which are freely keyed, by interposing bearings, on said fixed supporting shaft.

The reciprocating motion of the pistons is achieved by engaging them so that they follow over 360° the profile of a fixed eccentric element having a circular cross-section by virtue of the coupling of connecting rods, in which the big end is freely inserted in said profile of the eccentric element while the small end is inserted in the pin of the piston, the axis of said eccentric element being offset and parallel to the axis of the engine, i.e., to the axis that constitutes simultaneously both the axis of said fixed supporting shaft and the rotation axis of the rotor, within which the pistons slide with a reciprocating motion, said pistons being four or six.

In this solution, the rotor operates by turning about its own axis; clearly, the inserted cylinders, by following this rotation, force the pistons to slide within their walls, said pistons being coupled by connecting rods which are connected to the eccentric element; this produces a reciprocating rectilinear motion and cyclically varies, with a 360° period, the volume of the combustion chamber formed between the head of the piston and the head of the cylinder, constituted by the internal surface of the stator.

The eccentricity of the axis of the eccentric element with respect to the axis of the engine has such a value that it is possible to produce continuously, in each one of the combustion chambers that correspond to the pistons, a continuous variation of their volumes, thus ensuring an operation which is similar to the operation of a conventional internal-combustion engine of the four-stroke type (intake, compression, power, exhaust).

The device used by the piston to continuously follow the circular profile of the eccentric element has a connecting rod for each piston; said connecting rod is keyed at one end to said pin and at the other end to the eccentric surface, with a bearing or roller cage inserted.

The advantages of the operation of the two-stroke engine produced by the absence of the distribution mechanisms are achieved with the engine according to the invention by providing a distribution which is controlled by the rotor, during its 360° rotation, which gradually opens and closes two ports formed in the body of the stator, i.e., an inlet port for the air-fuel mix and an exhaust port for the burnt gases.

### BRIEF DESCRIPTION OF THE DRAWINGS

The torque obtained by virtue of the rotation of the rotor is transferred outside the engine by keying on the hub of one of the two lateral walls of said rotor a gear which meshes with a fixed-axis pinion which is rigidly coupled to the stator and in turn rotates external power take-offs which are used for example for the operation of the starter motor, of the oil pump, of the electronic contacts, and the power take-off for traction.

These and other characteristics of the invention will become better apparent from the description of a preferred embodiment, given only by way of non-limitative example with the aid of the accompanying drawings, wherein:

FIG. 1 is a sectional elevation view of the engine according to the invention in one of its embodiments;

FIG. 2 is a sectional side view of the engine, taken along the line I-I of FIG. 1;

FIGS. 3 and 4 are views of the shaft assembly, with the eccentric element, the connecting rod assembly and the pistons;

FIG. 5 is a detail view of the shaft with the eccentric element and the bearing;

FIG. 6 is a side view of the shaft of FIG. 5;

FIG. 7 is a sectional side view, taken along the line II-II of FIG. 5;

FIG. 8 is a sectional detail view of the stator;

FIG. 9 is a side view of the stator of FIG. 8;

FIG. 10 is a sectional side view, taken along the line III-III of FIG. 8;

FIG. 11 is a sectional detail view of the rotor;

FIG. 12 is a side view of the rotor of FIG. 11;

FIG. 13 is a sectional side view of the rotor of FIG. 12.

### WAYS OF CARRYING OUT THE INVENTION

As shown in the figures, the rotary internal-combustion engine according to the invention is composed of a fixed body 1 or stator inside which a movable body or rotor 2 rotates coaxially.

The regions of contact between the two bodies 1 and 2, specifically the internal surface 3 of the stator and the external surface 4 of the rotor, have a spherical profile.

In the body of the rotor 2, which is shaped like a spherical sector with two flat faces, there are four equidistant radial cavities 5 which are meant to accommodate the cylinders 6 in which four pistons 7 can respectively slide with a reciprocating rectilinear motion.

The ports 8, 9 respectively for discharging the burnt products and for aspirating the air-fuel mix, and the seat 10 for the spark-plug 11, are formed in the fixed body or stator 1.

The rotor 2 has two lateral flanges 12 which are freely supported by means of bearings 13 on a fixed shaft 14 which is coaxial and is supported by the lateral flanges 15, which are rigidly coupled to the body of the stator 1.

The fixed shaft 14 has, in its central region, an eccentric body 16 which has a circular profile and an offset axis 17 which is parallel to the central rotation axis 18 of the rotor 2.

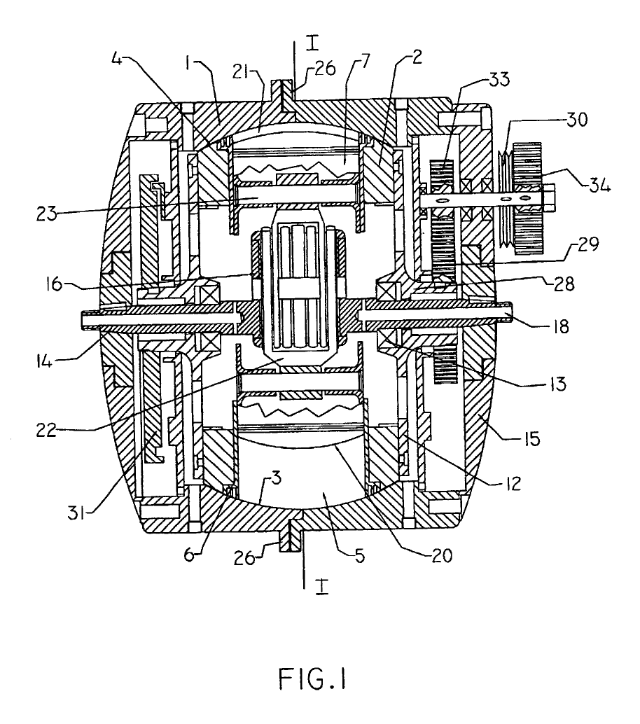

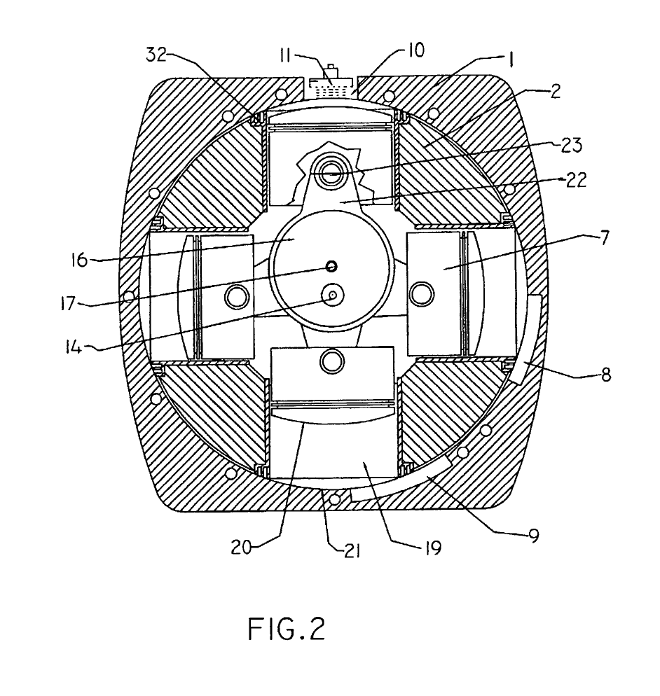

As shown in FIGS. 1 and 2, the pistons are engaged so as to follow through 360° the circular profile of the eccentric element 16 by means of connecting rods 22, so that said pistons are forced to perform a reciprocating rectilinear motion inside the corresponding cylinders 6, thus varying continuously the volume of the combustion chamber 19 formed between the head of the piston 20 and the head 21 of the cylinder, constituted by the internal surface 3 of the stator 1, both of which have a spherical profile.

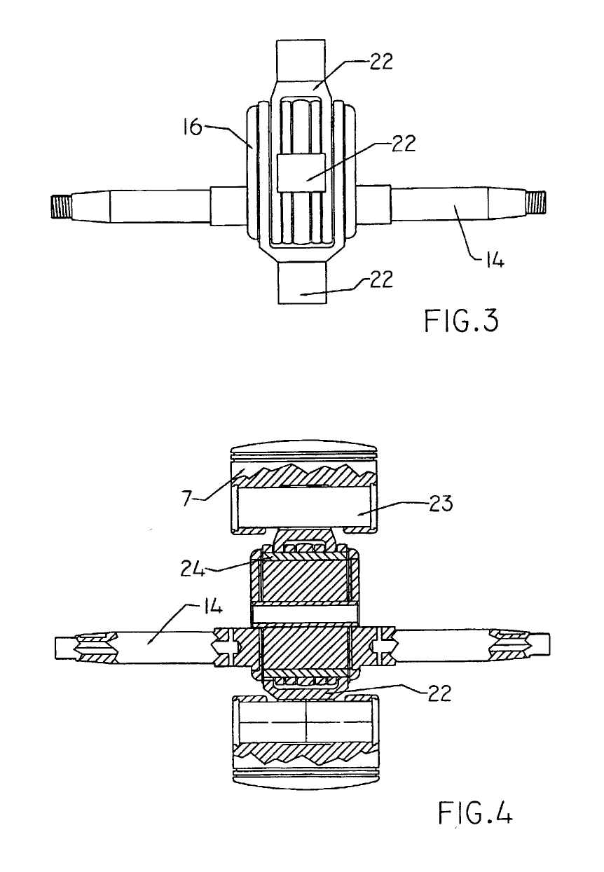

As shown specifically in FIGS. 1, 2 and 4, the method for engaging the piston so that during its 360° rotation it follows the profile of the eccentric element consists in using a connecting rod 22 which is keyed at one end to the pin 23 of the piston 7 and at the other end, freely and by way of a bearing 24, to the surface of the eccentric element 16; in this manner, the rotor, by turning through 360°, moves the piston, which being coupled to the connecting rod is forced to perform a rectilinear reciprocating motion.

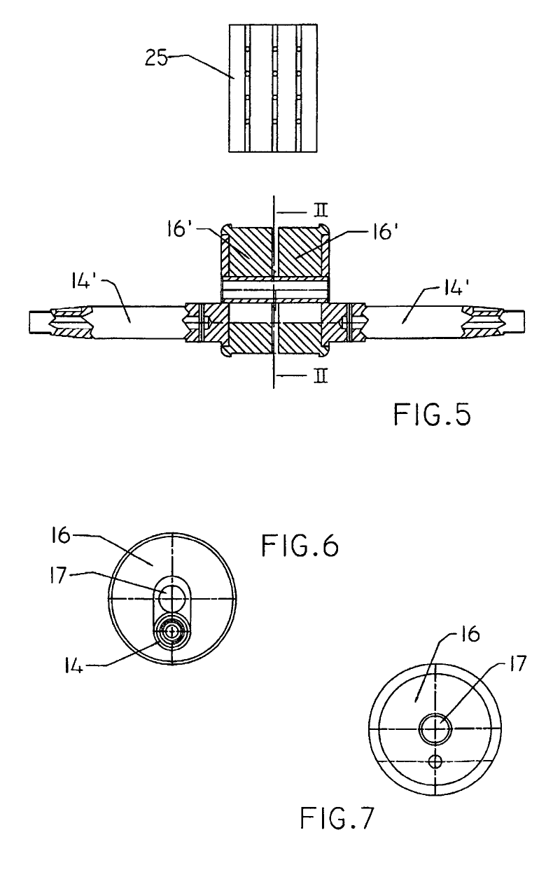

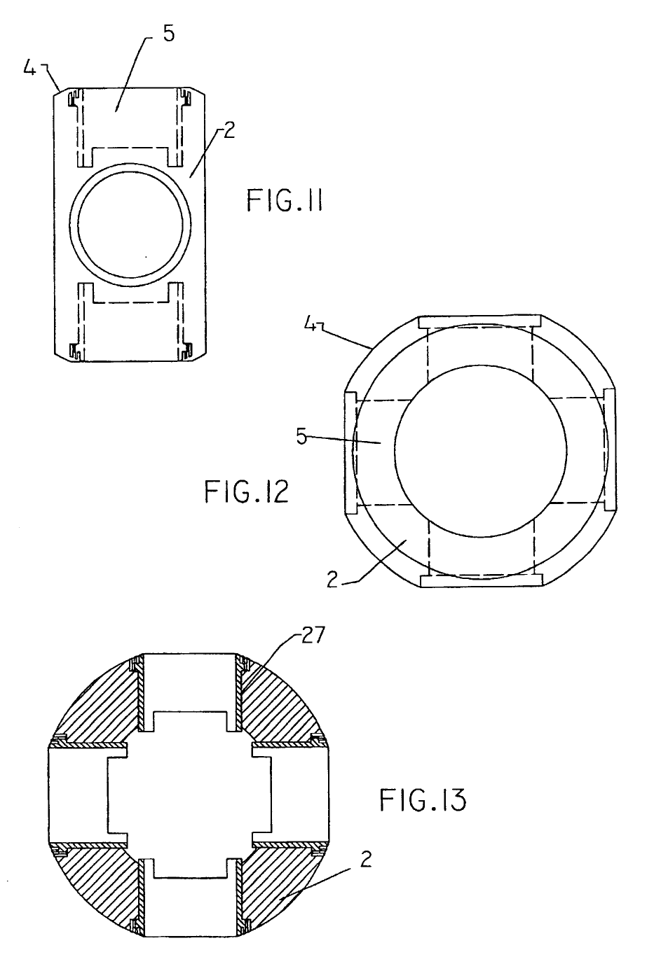

FIGS. 5 to 12 illustrate constructive details related to the three elements that characterize the engine according to the invention, i.e., the fixed shaft with eccentric element, the stator, and the rotor, respectively.

As shown in FIGS. 5 to 7, the fixed shaft with eccentric element is formed by two separate symmetrical elements, each constituted by a shaft portion 14′ provided each with a eccentric element portion 16′, which are separated at the central plane of the engine and are joined by way of a pin which passes through the axis 17 of the eccentric element, with a bearing 25 keyed thereto.

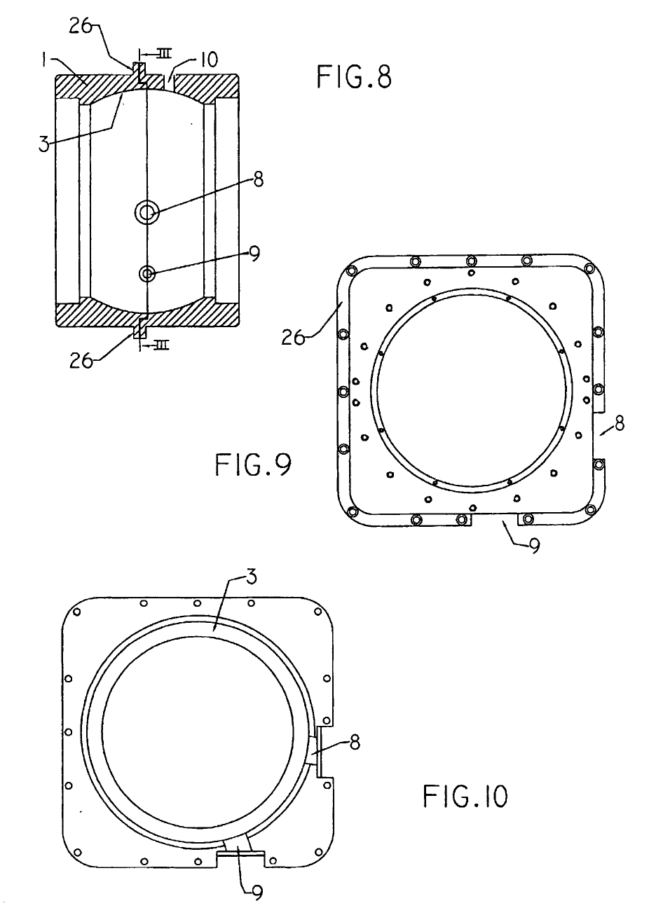

As shown in FIGS. 8 to 10, the stator 1, which is characterized in that its internal surface 3 has a spherical profile, is composed of two distinct symmetrical elements which are separated at the central plane III-III of the engine and are joined by the coupling of external flanges 26.

As shown in FIGS. 11 to 13, the rotor 2, which has a spherical profile, is constituted by a single metallic block on which the liners 27 that form the cylinders 6 are inserted in the four radial opposite cavities 5.

As shown in FIG. 1, the torque obtained by way of the rotation of the rotor 2 is transferred outside the engine by keying onto a hub 28, of at least one of the two lateral flanges 12 of said rotor, a gear 29 which rotationally meshes with external power take-offs, such as the pulley 30 and the gear 34 for engagement of the starter motor and the power distribution of the engine, while through a further flange 31 controls the electronic contact.

The disclosures in Italian Patent Application No. VI2000A000076 from which this application claims priority are incorporated herein by reference.

1. A spark-ignition rotary internal-combustion engine, characterized in that it has a plurality of pistons (7) which perform a reciprocating motion inside cylinders (6) which are arranged so as to be equally angularly spaced on a same circumference, said cylinders (6) being inserted in appropriately provided seats (5) in a rotating body or rotor (2) which rotates coaxially inside a fixed body or stator (1), in which the inlet duct (9) for the air-fuel mix, the burnt gas exhaust duct (8) and the spark-plug seat (10) are provided.

2. The spark-ignition rotary internal-combustion engine according to claim 1, characterized in that the region of contact, with minimum tolerance, between the outer surface (4) of the rotor (2) and the inner surface (3) of the stator (1) is shaped like a spherical surface or region.

3. The spark-ignition rotary internal-combustion engine according to claim 2, characterized in that the rotor (2) is shaped like a spherical sector with two bases.

4. The spark-ignition rotary internal-combustion engine according to claim 3, characterized in that the rotor (2) is supported by a supporting shaft (14) which is fixed and rigidly coupled to the body of the stator (1).

5. The spark-ignition rotary internal-combustion engine according to claims 1 to 4, characterized in that the reciprocating motion of the pistons (7) is produced by engagement thereof so that they follow through 360°, by way of connecting rods (22), the profile of an eccentric element (16) whose axis (17) is offset and parallel with respect to the engine axis (18), i.e., to the axis (18) that simultaneously constitutes both the axis of the rotor supporting shaft (14) and the rotation axis of said rotor (2), within which said pistons (7) can slide with a reciprocating motion.

6. The spark-ignition rotary internal-combustion engine according to claim 5, characterized in that the eccentric element (16) accommodates, within its circumference, a bearing or roller cage (24) on the surface of which the small end of the connecting rod (22) slides.

7. The spark-ignition rotary internal-combustion engine according to claims 1 to 6, characterized in that it comprises a fixed body or stator (1), within which a movable body or rotor (2) rotates coaxially, the regions of contact between said two bodies (1, 2), specifically the internal surface (3) of the stator and the outer surface (4) of the rotor, being shaped like the spherical region of a spherical sector with two flat faces, constituted by the body of said rotor (2), equidistant radial cavities (5) being formed within said rotor and constituting the cylinders (6) within which the pistons (7) can slide respectively with a reciprocating rectilinear motion, the ports (8, 9), respectively for discharging the burnt products and for aspirating the air-fuel mix, and the seat (10) for the spark-plug (11) being formed within said stator.

8. The spark-ignition rotary internal-combustion engine according to claim 7, characterized in that the engine (2) is provided with lateral flanges (12) which are freely supported by way of bearings (13) on a fixed shaft (14) which is coaxial to said engine and is supported by the lateral flanges (15), which are rigidly coupled to the body of the stator (1).

9. The spark-ignition rotary internal-combustion engine according to claim 8, characterized in that the fixed shaft (14) has, in its median position, an eccentric body (16) which has a circular profile, with an axis (17) which is offset and parallel to the central axis (18) about which the rotor (2) turns, the pistons (7) being engaged so as to follow cyclically through 360°, through coupling of the connecting rods (22), the profile of the eccentric element (16), and so that they are forced to perform a reciprocating rectilinear motion inside the corresponding cylinders (6), thus varying continuously the volume of the combustion chamber (19) formed between the head (20) of the piston and the head (21) of the cylinder (6) formed by the internal surface (3) of the stator (1).

10. The spark-ignition rotary internal-combustion engine according to claim 9, characterized in that the piston (7) is engaged so as to follow the profile of the eccentric element (16) through a connecting rod (22) which is keyed at one end to the pin (23) of the piston (7) and, at the other end, freely through a bearing (25) which is fixed in the circular surface of the eccentric element (16).

11. The spark-ignition rotary internal-combustion engine according to claim 10, characterized in that the fixed shaft (14) with eccentric element (16) is formed by two distinct symmetrical elements, each constituted by a shaft portion (14′) provided each with an eccentric element portion (16′), separated at the central plane of the engine and joined by way of a pin (17) which is coaxial to the axis (17) of the eccentric element (16).

12. The spark-ignition rotary internal-combustion engine according to one or more of the preceding claims, characterized in that the stator (1) has an internal surface (3) which has a spherical profile and is composed of two distinct symmetrical elements which are separated at the central plane of the engine and are joined by virtue of the coupling of the external flanges (26).

13. The spark-ignition rotary internal-combustion engine according to one or more of the preceding claims, characterized in that the rotor (2), which is shaped like a spherical sector with two flat faces, is constituted by a single metallic block in the radial cavities of which the liners (27) that form the cylinders (6) are inserted.

14. The spark-ignition rotary internal-combustion engine according to one or more of the preceding claims, characterized in that the torque obtained through rotation of the rotor (2) is transferred outside the engine by keying onto the hub (28) of at least one of the two lateral flanges (12) of said rotor a gear (29) which meshes with a pinion (33) which has an axis through which rotates external power take-offs such as the pulley (30) and the-gear (34), in order to operate the starter motor, or the flange (31) that controls the electronic contact.

15. The spark-ignition rotary internal-combustion engine according to one or more of the preceding claims, characterized in that it comprises four pistons (7) arranged radially on the rotor (2).

16. The spark-ignition rotary internal-combustion engine according to one or more of the preceding claims, characterized in that it comprises six pistons (7) arranged radially on the rotor (2).

17. The operation of a spark-ignition rotary internal-combustion engine as described in one or more of the preceding claims, characterized in that when the rotor (2) turns about its own axis (18) it turns the cylinders (6) formed inside it, in which the corresponding pistons (7) can slide, but since said pistons (7) are simultaneously forced to follow the profile of the eccentric element (16), which is coaxial with said rotation axis, said pistons (7) are therefore forced to perform a reciprocating rectilinear motion inside said cylinders (6), thus varying, in a cyclic manner through 360°, the volume of the combustion chamber (19) formed between the head (20) of is the piston (7) and the head of the cylinder, constituted by the internal surface of the stator.

18. The spark-ignition rotary internal-combustion engine as set forth in one or more of the preceding claims, characterized in that the eccentricity of the axis (17) of the eccentric element (16) with respect to the axis (18) of the engine has such a value as to provide continuously, in each one of the combustion chambers (19) that correspond to the pistons (7), a continuous variation of the volume thereof, whereby to ensure an operation which is similar to the operation of a conventional four-stroke engine, with the steps of intake, compression, power and exhaust, in order of sequence.
